(19) United States
(12) Patent Application Publication
(10) Pub. No.: US 2010/0105797 A1
(43) Pub. Date: Apr. 29, 2010

(54) SEALING MATERIAL, PROCESS FOR PRODUCTION OF THE MATERIAL, AND GASKET USING THE MATERIAL

(75) Inventors: Toshihiko Hiraiwa, Kanagawa (JP); Naoyuki Ohmori, Kanagawa (JP); Toshihiko Kurata, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Chuo-ku, Tokyo (JP)

(21) Appl. No.: 11/995,859

(22) PCT Filed: Jul. 21, 2006
(86) PCT No.: PCT/JP06/14500

§ 371 Date: Apr. 11, 2008

(30) Foreign Application Priority Data
Jul. 22, 2005 (JP) 20059212689
Aug. 19, 2005 (JP) 2005-238460
Jun. 26, 2006 (JP) 2006-174993
Jul. 20, 2006 (JP) 2006-198172

(51) Int. Cl. C08L 75/04; C08G 18/06

(52) U.S. Cl. 522/90; 528/61; 524/874

(57) ABSTRACT

A sealing material which comprises (A) an unsaturated group-containing ester-type urethane oligomer which is an energy ray-curable liquid resin and (B) a compound having at least one carbodiimide group in the molecule in an amount of 0.01 to 10 parts by mass based on 100 parts by mass of the component (A) and which is excellent in moist heat durability, can retain low moisture permeability, is excellent in adhesion to a material to be jointed and can form a highly precise extrusion shape; a process for production of a scaling material excellent in long-term storage stability; a scaling material produced by the process; a gasket using a sealing material having the above-mentioned properties. A cured product of the sealing material has a reduced surface adhesion property, enables the easy removal of an HDD cover, and consequently is improved in durability against an external force produced at the time of reuse.

### BACKGROUND OF THE INVENTION

The present invention relates to a sealing material, more specifically to a sealing material which is excellent in a durability on a humid and hot condition and maintains a low moisture permeability and which provides an extruded form having a high precision, a production process for a sealing material which is excellent in a long term storage stability, a sealing material obtained by the above production process and gaskets prepared by using the above materials.

### RELATED ART

In recent years, a rise in performances and a reduction in size are advanced in hard disk units of computers, and they come to have complicated circuit constitutions. Troubles are caused even by a small amount of dusts, and therefore gaskets are usually used to prevent dusts from coming into the units.

Further, as a reduction in size is advanced as described above, gaskets are used for portable electronic devices in increasing cases, and they are used in severer environments in many cases as compared with conventional uses of PC, so that cases in which they are used in environments of high humidity and high temperature have to be assumed.

In urethane materials, involved therein are the problems that polyether base materials are excellent in a durability on a humid and hot condition but have a high moisture permeability and that on the other hand, polyester base materials are inferior in a durability on a humid and hot condition but have a low moisture permeability. Further, the polyester base materials have ester bonds in a molecule and therefore have the drawback that they are susceptible to hydrolysis. On the other hand, however, hydrogen bonds are produced between ester bonds, and they have a high solubility parameter as compared with those of the polyether base materials, so that urethanes are excellent in physical properties (particularly a heat resistance and a tear strength), thermal characteristics, an oil resistance and an adhesive property. Accordingly, strongly desired is a sealing material in which the problems described above are improved and which is excellent in a durability on a humid and hot condition and a low moisture permeability.

Further, a dispensing process in which a molten resin or a solubilized resin is extruded in the form of a gasket onto a plate face with one stroke by means of a dispenser to integrate them is widely used in an industrial scale as a production process of gaskets for hard disk units since it has the merit that steps such as an adhering step and the like are not required.

Further, in recent years, it is proposed that a material in which a dependency of a viscosity on a shearing speed is controlled to a large extent making use of a thixotropic phenomenon to provide a high viscosity at a low shearing speed and a low viscosity at a high shearing speed is used in order to accurately form a gasket shape by extrusion (refer to, for example, a patent document 1).

Organic thickeners, particularly, hydrogenated castor oil and amide waxes are swollen by heating in a state of dispersing in a material to form a network structure, whereby a thixotropic property is developed.

Usually, a material and a thixotropic agent are kneaded at a constant temperature only for time required for swelling by means of a mixer. However, involved therein are the following problems; this swelling takes time in many cases, and when taking time for sufficiently swelling during kneading, the productivity is reduced; if kneading is finished in a state in which swelling is insufficient, the material is increased in a viscosity with the passage of time; when this is used for a sealing material, a storage stability of the material is deteriorated, and the extruded shape is not obtained at a high accuracy.
Patent document 1: Japanese Patent Application Laid-Open No. 7047/2003

### DISCLOSURE OF THE INVENTION

An object of the present invention is to provide a sealing material which is excellent in a durability on a humid and hot condition and maintains a low moisture permeability and which provides an extruded form having a high precision, a production process for a sealing material which is excellent in a long term storage stability, a sealing material obtained by the above production process and gaskets prepared by using the materials having the above characteristics.

Intensive researches repeated by the present inventors in order to achieve the object described above have resulted in finding that the problems described above can be solved by adding a carbodiimide compound to an unsaturated group-containing ester base urethane oligomer which is an energy ray-curable liquid resin. Further, a sealing material obtained by adding a specific monomer component to the above material shows a lower moisture permeability and is excellent in an adhesive property with an adherend, and the above material after cured is less sticky. The present invention has been completed based the above knowledge.

That is, the present invention provides:
(1) A sealing material comprising an unsaturated group-containing ester base urethane oligomer (A) which is an energy ray-curable liquid resin and 0.01 to 10 mass parts of a compound (B) containing at least one carbodiimide group in a molecule per 100 mass parts of the above component (A).
(2) The sealing material as described in the above item (1), wherein the energy ray-curable liquid resin (A) is represented by the following Formula (I):

R¹—O—CONH—R²—NHCO—(—O—R³—O—CONH—R²—NHCO)ₚ-(-A-CONH—R²—NHCO—)_{q}—(—O—R³—O—CONH—R²—NHCO—)ᵣ—O—R¹ (I)

[in Formula (I), R¹ is a hydroxyl group-eliminated residue of a monool compound containing at least either unsaturated group of a (meth)acryloyl group and a vinyl group; R² is an isocyanate-eliminated residue of an organic diisocyanate compound; R³ is a hydroxyl group-eliminated residue of a polyesterdiol compound having a number average molecular weight of 1×10³ to 1×10⁴ and containing a cyclic group or a branched chain group; A is a hydrogen group-eliminated residue of a diamine compound or a hydrogen group-eliminated residue of a diol compound; p and r each are 0 to 7, and q is 0 to 3, provided that when q is 0, 1≦p+r≦10] and is an unsaturated group-containing urethane oligomer having a number average molecular weight of 5×10³ to 5×10⁴.
(3) The sealing material as described in the above item (2), wherein R³ in Formula (I) is a hydroxyl group-eliminated residue of the polyesterdiol compound described above which is obtained by condensing cyclic group-containing dicarboxylic acid with diol or a hydroxyl group-eliminated residue of the polyesterdiol compound modified by reacting cyclic group-containing dicarboxylic anhydride with diol.
(4) The sealing material as described in the above item (2), wherein R¹ in Formula (I) is a hydroxyl group-eliminated residue of the monool compound described above which is either of hydroxyalkyl (meth)acrylate and hydroxyalkyl vinyl ether.
(5) The sealing material as described in any of the above items (1) to (4), wherein the unsaturated group-containing urethane oligomer (a case of q=0 in Formula (I)) of the component (A) is obtained by subjecting the polyesterdiol compound described above and the organic diisocyanate compound described above to polyaddition reaction to form an adduct having isocyanate groups at both ends and then adding the monool compound described above to the above isocyanate groups.
(6) The sealing material as described in any of the above items (1) to (4), wherein the unsaturated group-containing urethane oligomer (a case of q≠0 in Formula (I)) of the component (A) is obtained by subjecting the polyesterdiol compound described above and the organic diisocyanate compound described above to polyaddition reaction to form an adduct having isocyanate groups at both ends, then adding each end of the diamine compound described above or the diol compound described above to the isocyanate group at one end of the above adduct and adding the monool compound described above to the isocyanate group at the other end of the above adduct.
(7) The sealing material as described in the above item (1), wherein the compound (B) containing a carbodiimide group is a liquid polycarbodiimide compound having a viscosity of 0.1 to 100 Pa·s.
(8) The sealing material as described in the above item (7), wherein the component (B) described above is a liquid polycarbodiimide compound having a viscosity of 0.5 to 10 Pa·s.
(9) The sealing material as described in any of the above items (1) to (8), further comprising a thickener (C) imparting a thixotropic property.
(10) The sealing material as described in the above item (9), comprising 0.5 to 10 mass parts of the thickener (C) per 100 mass parts of the component (A).
(11) The sealing material as described in the above item (9) or (10), wherein the thickener (C) is an organic thickener.
(12) The sealing material as described in the above item (11), wherein the organic thickener is hydrogenated castor oil.
(13) The sealing material as described in any of the above items (1) to (12), further comprising at least one of a photopolymerization initiator, a cross-linking agent and a monomer as a component (D).
(14) The sealing material as described in the above item (13), comprising 1 to 70 mass parts of a (meth)acrylic acid ester monomer as the component (D) per 100 mass parts of the component (A).
(15) The sealing material as described in the above item (14), wherein the (meth)acrylic acid ester monomer described above has a glass transition temperature of 50° C. or higher.
(16) The sealing material as described in the above item (15), wherein the (meth)acrylic acid ester monomer described above is dicyclopentanyl (meth)acrylate and/or isobornyl(meth)acrylate.
(17) A production process for the sealing material comprising the energy ray-curable liquid resin (A), the compound (B) containing at least one carbodiimide group in a molecule and the thickener (C) each described in any of the above items (1) to (16), comprising a step (step 1) of stirring and mixing the component (A), the component (B) and the component (C) by means of a mixer and a step (step 2) of aging (curing) the obtained mixed liquid in a constant temperature bath.
(18) The production process for the sealing material as described in the above item (17), wherein a temperature in stirring and mixing by the mixer in the step 1 described above falls in a range of 30 to 120° C.
(19) The production process for the sealing material as described in the above item (17), wherein in the step 2, a temperature in the aging falls in a range of 40 to 100° C., and the aging is continued until a rate of a change in a viscosity (Pa·s) of the mixed liquid at the aging temperature after 8 hours reaches 5% or less.
(20) The production process for the sealing material as described in any of the above items (17) to (19), wherein the mixed liquid after finishing the step 2 has a viscosity of 1 to 100 Pa·s at a shear rate of 10 s⁻¹ at 50° C.
(21) A sealing material obtained by using the production process as described in any of the above items (17) to (20).
(22) A gasket obtained by curing the sealing material as described in any of the above items (1) to (15).
(23) A gasket obtained by curing the sealing material as described in the above item (21).

### BRIEF DESCRIPTION OF THE DRAWINGS

FIG. 1 is a schematic drawing showing a change in a viscosity of a sealing material with the passage of time which shows a conventional example.

FIG. 2 is a schematic drawing showing a change in a viscosity of a sealing material with the passage of time which shows the embodiment of the present invention.

### BEST MODE FOR CARRYING OUT THE INVENTION

The sealing material of the present invention has to comprise an unsaturated group-containing ester base urethane oligomer (A) which is an energy ray-curable liquid resin and 0.01 to 10 mass parts of a compound (B) containing at least one carbodiimide group in a molecule per 100 mass parts of the above component W.

The unsaturated group-containing ester base urethane oligomer (A) which is the energy ray-curable liquid resin of the component (A) is represented by Formula (I) described above.

In Formula (I), R¹ is a hydroxyl group-eliminated residue of a monool compound containing at least either unsaturated group of a (meth)acryloyl group and a vinyl group.

The monool compound includes preferably hydroxyalkyl(meth)acrylate and hydroxyalkyl vinyl, and it includes, for example, diethylene glycol(meth)acrylate, dipropylene glycol(meth)acrylate, tripropylene glycol(meth)acrylate, triethylene glycol(meth)acrylate, polyethylene glycol(meth)acrylate and the like. The (meth)acryloyl group means an acryloyl group or a methacryloyl group.

R² is an isocyanate-eliminated residue of an organic diisocyanate compound. It includes, for example, an alkylene group such as methylene, ethylene, propylene, butylene, hexamethylene and the like, a cycloalkylene group such as cyclohexylene and the like, an arylene group such as phenylene, tolylene, naphthylene and the like and xylylene. In this connection, the alkyl group may be any of linear, branched and cyclic groups. The organic diisocyanate compound includes preferably isophoronediisocyanate, hexamethylenediisocyanate, norbornanediisocyanate, tolylenediisocyanate, xylenediisocyanate, trimethylhexamethylenediisocyanate, naphthalenediisocyanate, hydrogenated xylylenediisocyanate, hydrogenated diphenylmethanediisocyanate, diphenylmethanediisocyanate and the like.

R³ is a hydroxyl group-eliminated residue of a polyesterdiol compound having a number average molecular weight of 1×10³ to 1×10⁴ and containing a cyclic group or a branched chain group.

Among them, R³ is preferably a hydroxyl group-eliminated residue of the polyesterdiol compound described above which is obtained by condensing cyclic group-containing dicarboxylic acid with diol or a hydroxyl group-eliminated residue of the polyesterdiol compound modified by reacting cyclic group-containing dicarboxylic anhydride with diol.

The cyclic group-containing dicarboxylic acid or anhydride thereof constituting R³ includes, for example, phthalic acid, phthalic anhydride, pyromellitic acid, pyromellitic anhydride, isophthalic acid, trimellitic acid, trimellitic anhydride, tetrahydrophthalic acid, tetrahydrophthalic anhydride, hexahydrophthalic acid, hexahydrophthalic anhydride and the like. The above compounds may be used in a mixture of a plurality thereof.

The diol constituting R³ includes, for example, ethylene glycol, propylene glycol, 2,2,4-trimethyl-1,3-pentanediol, neopentyl glycol, 1,2-propanediol, 1,3-propanediol, 1,4-propanediol, 1,3-butanediol, 1,5-pentanediol, 1,6-hexanediol, 2,2-dimethyl-1,3-propanediol, bisphenol A, tetraethoxyxylate, 2,2-thiodiethanol, acetylene type diols, hydroxy-end polybutadiene, 1,4-cyclohexanedimethanol, 1,2-cyclohexanedimethanol, 1,3-cyclohexanedimethanol, 1,4-bis(2-hydroxyethoxy)cyclohexane, trimethylene glycol, tetramethylene glycol, pentamethylene glycol, hexamethylene glycol, decamethylene glycol, diethylene glycol, triethylene glycol, tetraethylene glycol, norbonylene glycol, 1,4-benzenedimethanol, 1,4-benzeneethanol, 2,4-dimethyl-2-ethylenehexane-1,3-diol, 2-butene-1,4-diol, 2,4-diethyl-1,5-pentanediol, 2-ethyl-2-butyl-1,3-propanediol, 3-methyl-1,5-pentanediol and the like.

In Formula (I), A is a hydrogen group-eliminated residue of a diamine compound or a hydrogen group-eliminated residue of a diol compound.

The above compound shall not specifically be restricted and is preferably a hydrogen group-eliminated residue of the diamine compound selected from, for example, diaminopropane, diaminobutane, nonanediamine, isophoronediamine, hexamethylenediamine, hydrogenated diphenylmethanediamine, bisaminopropyl ether, bisaminopropylethane, bisaminopropyl diethylene glycol ether, bisaminopropyl polyethylene glycol ether, bisaminopropoxyneopentyl glycol, diphenylmethanediamine, xylylenediamine, toluenediamine and both end amino group-modified silicone and a hydrogen group-eliminated residue of the diol compound selected from ethylene glycol, propylene glycol, polyethylene glycol, polypropylene glycol, butylene glycol, polytetramethylene glycol, pentanediol, hexanediol, both end hydroxyl group-modified silicone and a carboxyl group-containing diol.

R¹ is preferably a hydroxyl group-eliminated residue of the monool compound which is either of hydroxyalkyl (meth)acrylate and hydroxyalkyl vinyl ether, and it includes, for example, a hydroxyl group-eliminated residue of hydroxyethyl acrylate, hydroxymethyl vinyl ether or the like.

The urethane oligomer (A) described above can preferably be produced by the following process.

The unsaturated group-containing urethane oligomer in a case of q=0 in Formula (I) can be obtained by subjecting the polyesterdiol compound described above and the organic diisocyanate compound described above to polyaddition reaction to form an adduct having isocyanate groups at both ends and then adding the monool compound described above to the above isocyanate groups.

Further, the unsaturated group-containing urethane oligomer in a case of q≠0 in Formula (I) can be obtained by subjecting the polyesterdiol compound described above and the organic diisocyanate compound described above to polyaddition reaction to form an adduct having isocyanate groups at both ends, then adding each end of the diamine compound described above or the diol compound described above to the isocyanate group at one end of the above adduct and adding the monool compound described above to the isocyanate group at the other end of the above adduct.

The unsaturated group-containing urethane obtained in the manner described above has preferably a number average molecular weight of 5×10³ to 5×10⁴, but the molecular weight may exceed 5×10⁴ as long as the effects of the present invention are not damaged.

Next, the compound (hereinafter referred to merely as the “carbodiimide compound”) containing a carbodiimide group which is the component (B) has to have at least one carbodiimide group represented by —N═C═N— in a molecule, and it is reacted with active hydrogen (carboxylic acids, amines, alcohols, thiols and the like) of carbodiimide.

As described above, the function of the carbodiimide compound is to react, at an initial stage after addition, with a hydroxyl group and a carboxyl group remaining in the unsaturated group-containing urethane oligomer which is the component (A) considered to accelerate hydrolysis to control the hydrolysis and to be then added to and recombined with an ester bond cut by the hydrolysis reaction to repair it. However, low molecular substances such as monocarbodiimide and the like are liable to be thermally decomposed in processing to produce irritating odor components to thereby pollute the environment and are reduced in an addition effect by vaporization, and therefore polycarbodiimide is preferably used.

Compounds synthesized by usually well known processes can be used as the compound having at least one carbodiimide group in a molecule (including polycarbodiimide compounds) which is used in the present invention, and capable of being given are, for example, compounds which can be synthesized by subjecting various polyisocyanates to decarbonization condensation reaction at a temperature of about 70° C. or higher in the absence of a solvent or in an inert solvent using an organic phosphorus base compound or an organic metal compound as a catalyst.

Aromatic diisocyanates, aliphatic diisocyanates, alicyclic diisocyanates and mixtures thereof can be given as the organic diisocyanates which are synthetic raw materials in producing the polycarbodiimide compounds. To be specific, capable of being given as the examples thereof are 1,5-naphthalenediisocyanate, 4,4′-diphenylmethanediisocyanate, 4,4′-diphenyldimethylmethanediisocyanate, 1,3-phenylenediisocyanate, 1,4-phenylenediisocyanate, 2,4-tolylenediisocyanate, 2,6-tolylenediisocyanate, a mixture of 2,4-tolylenediisocyanate and 2,6-tolylenediisocyanate, hexamethylenediisocyanate, cyclohexane-1,4-diisocyanate, xylylenediisocyanate, isophoronediisocyanate, cyclohexylmethane-4,4′-diisocyanate, methylcyclohexanediisocyanate, tetramethylxylylenediisocyanate, 2,6-diisopropylphenylisocyanate, 1,3,5-triisopropylbenzene-2,4-diisocyanate and the like.

In the case of the polycarbodiimide compounds described above, the polymerization reaction can be terminated in the middle by cooling and the like to control the polymerization degree to a suitable level. In this case, the end is isocyanate.

Further, a method in which a compound reacting with end isocyanates of the polycarbodiimide compounds such as monoisocyanates and the like is used to mask all or a part of remaining end isocyanates is available for controlling the polymerization degree to a suitable level. Controlling of the polymerization degree makes it possible to enhance the compatibility with the polymer and the storage stability, and it is preferred in terms of improving the quality.

Examples which can be shown as the monoisocyanates for masking the ends of the above polycarbodiimide compounds to control a polymerization degree thereof include, for example, phenylisocyanate, tolylisocyanate, dimethylphenylisocyanate, cyclohexylisocyanate, butnylisocyanate, naphthylisocyanate and the like.

An end masking agent for masking the ends of the polycarbodiimide compounds to control a polymerization degree thereof shall not be restricted to the monoisocyanates described above, and capable of being given as the examples thereof are active hydrogen compounds which can react with isocyanates, for example, (i) aliphatic, aromatic or alicyclic compounds having an OH group such as methanol, ethanol, phenol, cyclohexanol, N-methylethanolamine, polyethylene glycol monomethyl ether, polypropylene glycol monomethyl ether and the like; (ii) compounds having a ═NH group such as diethylamine, dicyclohexylamine and the like; (iii) compounds having a —NH₂ group such as butylamine, cyclohexylamine and the like; (iv) compounds having a —COOH group such as succinic acid, benzoic acid, cyclohexanoic acid and the like; (v) compounds having a —SH group such as ethylmercaptan, allylmercaptan, thiophenol and the like; (vi) compounds having an epoxy group; (vii) acetic anhydride, methyltetrahydrophthalic anhydride, methylhexahydrophthalic anhydride and the like.

Decarbonization condensation reaction of the organic diisocyanates described above is carried out under the presence of a suitable carbodiimidation catalyst. The carbodiimidation catalyst which can be used is suitably organic phosphorus base compounds and organic metal compounds (compounds represented by a formula M-(OR)₄ EM represents titanium (Ti), sodium (Na), potassium (K), vanadium (V), tungsten (W), hafnium (Hf), zirconium (Zr), lead (Pb), manganese (Mn), nickel (Ni), calcium (Ca), barium (Ba) and the like, and R represents an alkyl having 1 to 20 carbon atoms or an aryl group)), and phosphorene oxides in the case of the organic phosphorus base compounds and alkoxides of titanium, hafnium and zirconium in the case of the organic metal compounds are preferred particularly in terms of activities.

The preferred carbodiimide compound (B) obtained in the manner described above includes 4,4′-dicyclohexylmethanecarbodiimide, tetramethylxylylenecarbodiimide, N,N-dimethylphenylcarbodiimide, N,N′-di-2,6-diisopropylphenylcarbodiimide and the like. It shall not specifically be restricted as long as it is a compound having two or more carbodiimide groups in a molecule, and the aliphatic polycarbodiimide compounds are preferred in terms of a hue, a safety and a stability.

The carbodiimide compound (B) is preferably liquid in order to make it easy to mix and disperse in the component (A), and a viscosity of the component (B) is preferably 0.1 to 100 Pa·s, more preferably 0.5 to 10 Pa·s from the viewpoint that it is liquid.

A viscosity of the component (B) is measured at a measuring temperature of 25° C. according to JIS Z8803.

Allowing a viscosity of the component (B) to fall in the range described above makes it possible to inhibit the component (B) from vaporizing which is a problem in a working environment and facilitate mixing and dispersing it.

The above liquid carbodiimide compounds can be available as well in the form of commercial products and include, for example, trade name “Elastostab H01”, viscosity: 1 to 6 Pa·s, manufactured by Nisshinbo Industries, Inc.

An amount of the carbodiimide compound (B) falls in a range of 0.01 to 10 mass parts, preferably 0.01 to 5 mass parts and particularly preferably 0.1 to 3.0 mass parts per 100 mass parts of the component (A). Allowing the blend amount to fall in the range described above makes it possible to enhance a hydrolysis resistance of an easily hydrolyzable resin having an ester group.

Next, the thickener providing a thixotropic property as the component (C) which is added in the photocurable composition of the present invention is added preferably in an amount of 0.5 to 10 mass parts per 100 mass parts of the unsaturated group-containing urethane oligomer of the component (A) described above. Use of the above thickener providing a thixotropic property in combination with the specific urethane oligomer of the component (A) makes it possible to effectively enhance a thixotropic property and process the extruded form by controlling at a good precision. From this point of view, an addition amount of the component (C) is more preferably 1 to 5 mass parts. Both of an inorganic filler and an organic thickener can be used as the above thickener providing a thixotropic property.

The inorganic filler includes surface-treated fine powder silicas of wet silica and dry silica and natural minerals such as organized bentonite. To be specific, it includes silica fine powders pulverized by a dry method (for example, trade name: Aerosil 300 and the like, manufactured by Nippon Aerosil Co., Ltd.), fine powders obtained by modifying the above silica fine powders with trimethyldisilazane (for example, trade name: Aerosil RX300 and the like, manufactured by Nippon Aerosil Co., Ltd.), fine powders obtained by modifying the silica fine powders described above with polydimethylsiloxane (for example, trade name: Aerosil RY300, manufactured by Nippon Aerosil Co., Ltd.) and the like. An average particle diameter of the inorganic filler is preferably 5 to 50 μm, more preferably 5 to 12 μm from the viewpoint of a thickening property.

The organic thickener includes amide waxes, hydrogenated castor oil, mixtures thereof and the like. To be specific, it includes hydrogenated castor oil (for example, trade name: ADVITROL 100, manufactured by Sud-Chemie Catalysts Inc., trade name: Disparlon 305, manufactured by Kusumoto Chemicals, Ltd., and the like) which is a hydrogenated product of castor oil (consisting mainly of nondrying oil of ricinolic acid) and high-grade amide waxes which are products obtained by substituting hydrogen of ammonia with an acyl group (for example, trade name: Disparlon 6500, manufactured by Kusumoto Chemicals, Ltd.) and the like.

Among the above thickeners providing a thixotropic property, the organic thickeners are preferred. Impurities such as heavy metals are indispensably contained in the inorganic fillers of natural minerals, and in the surface-treated fine powder silicas, a wetting property on the surface is changed, so that a viscosity of the composition is varied in a certain case. Further, gas which is hazardous to the instruments is produced during use in a certain case depending on the kind of the surface treating agent.

Further, among the organic thickeners, hydrogenated castor oil is particularly preferred since the amide waxes are enhanced in a cross-linking density due to the presence of amines originating in the raw materials and increased in a hardness in a certain case.

Also, in the photocurable composition of the present invention, at least one of a photopolymerization initiator, a cross-linking agent and a monomer can be added as a component (D). They are particularly preferably added when irradiating with a UV ray.

The photopolymerization initiator may be either an intramolecular cleavage type or a hydrogen drawing type. The intramolecular cleavage type includes benzoin derivatives, benzyl ketals (for example, trade name: Irgacure 651, manufactured by Ciba Specialty Chemicals K.K.), α-hydroxyacetophenones (for example, trade names: Darocure 1173 and Irgacure 184, manufactured by Ciba Specialty Chemicals K.K.), α-aminoacetophenones (for example, trade names: Irgacure 907 and Irgacure 369, manufactured by Ciba Specialty Chemicals K.K.), combined use of a-aminoacetophenones and thioxanthones (for example, isopropylthioxanthone, diethylthioxanthone), acylphosphine oxides (for example, trade name: Irgacure 819, manufactured by Ciba Specialty Chemicals K.K.) and the like. The hydrogen drawing type includes combined use of benzophenones and amines, combined use of thioxanthones and amines and the like. Further, the intramolecular cleavage type and the hydrogen drawing type may be used in combination. Among them, oligomerized α-hydroxyacetophenones and acrylated benzophenones are preferred. To be more specific, they include oligo[2-hydroxy-2-methyl-1-[4-(1-methylvinyl)phenyl]propanone] (for example, trade name: ESACURE KIP150, manufactured by Lamberiti S.P.A), acrylated benzophenone (for example, trade name: Ebecryl P136, manufactured by Daicel UCB Co., Ltd.), imideacrylate and the like.

The cross-linking agent suitably includes organic peroxides, and to be specific, it includes, for example, 2,5-dimethyl-2,5-di(t-butylperoxy)-hexane, 2,5-dimethyl-2,5-di(benzoylperoxy)-hexane, t-butylperoxy benzoate, dicumyl peroxide, t-butylcumyl peroxide, diisopropyl benzohydroperoxide, 1,3-bis-(t-butylperoxyisopropyl)-benzene, benzoyl peroxide, 1,1-di(t-butylperoxy)-3,3,5-trimethylcyclohexane and the like.

The monomer is preferably (meth)acrylic ester monomers. A molecular weight of the monomer is preferably less than 1,000, more preferably 150 to 600. The (meth)acrylic ester monomers include cyclohexyl(meth)acrylate, dicyclopentanyl(meth)acrylate, dicyclopentenyl(meth)acrylate, dicyclopentenyloxyethyl(meth)acrylate, diethylene glycol monoethyl ether(meth)acrylate, dimethylaminoethyl(meth)acrylate, dimethyloldicyclopentane di(meth)acrylate, dipropylene glycol(meth)acrylate, ethoxydiethylene glycol(meth)acrylate, ethoxylated phenyl(meth)acrylate, ethyl(meth)acrylate, isoamyl(meth)acrylate, isobornyl(meth)acrylate, isobutyl(meth)acrylate, isodecyl(meth)acrylate, isooctyl(meth)acrylate, isostearyle(meth)acrylate, isomyristyl(meth)acrylate, lauroxypolyethylene glycol(meth)acrylate, lauryl(meth)acrylate, methoxydipropylene glycol(meth)acrylate, methoxytripropylene glycol(meth)acrylate, methoxypolyethylene glycol(meth)acrylate, methoxytriethylene glycol(meth)acrylate and the like. (Meth)acrylate means acrylate or methacrylate.

Among the (meth)acrylic ester monomers, the monomers having a glass transition temperature (Tg) of 50° C. or higher are preferred. If the glass transition temperature (Tg) is 50° C. or higher, the satisfactory low moisture permeability can be obtained. Further, a surface adhesive property of the cured matter can be reduced, and the stickiness can be inhibited. On the other hand, an upper limit value of the glass transition temperature shall not specifically be restricted, but if the glass transition temperature is too high, the cured matter is increased too much, though depending on an addition amount of the (meth)acrylic ester monomer, in a hardness and is not preferred as a sealing material. Accordingly, it is preferably 150° C. or lower. From the viewpoint of balance between the low moisture permeability, the stickiness and the adhesive property, the glass transition temperature falls more preferably in a range of 80 to 130° C.

An alcohol residue of the (meth)acrylic ester monomer is preferably a hydrocarbon group having a cyclic structure having 5 to 16 carbon atoms. It is considered that the hydrocarbon group having a cyclic structure having 5 or more carbon atoms can provide the low moisture permeability because of a bulkiness thereof. On the other hand, the hydrocarbon group having 16 or less carbon atoms can provide the preferred glass transition temperature described above and the suitable hardness, and balance between the stickiness and the adhesive property is obtained. From the viewpoints described above, the alcohol residue of the (meth)acrylic ester monomer is more preferably a hydrocarbon group having a cyclic structure having 8 to 12 carbon atoms.

In particular, the (meth)acrylic ester monomers in which an alcohol residue is a bridged cyclic hydrocarbon group are preferred, and to be specific, they are suitably the (meth)acrylic ester monomers having a dicyclic alicyclic hydrocarbon group such as isobornyl(meth)acrylate and the like and the (meth)acrylic ester monomers having a tricyclic alicyclic hydrocarbon group such as dicyclopentanyl(meth)acrylate, dicyclopentenyl(meth)acrylate and the like. Further, the (meth)acrylic ester monomers having a saturated bridged cyclic hydrocarbon group are preferred.

To be more specific, isobornyl(meth)acrylate and dicyclopentanyl(meth)acrylate are particularly preferred.

The (meth)acrylic ester monomers described above may be used alone or in combination of two or more kinds thereof.

A content of the (meth)acrylic ester monomers falls preferably in a range of 1 to 70 mass parts per 100 mass parts of the component (A). If a content of the (meth)acrylic ester monomers is 1 mass part or more, the effects of adding the above monomers, that is, the low moisture permeability, an inhibition in the stickiness and the adhesive property to the adherend are sufficiently obtained, and if it is 70 mass parts or less, the disadvantage that the hardness is too high is not brought about. From the viewpoints described above, a content of the (meth)acrylic ester monomers falls more preferably in a range of 10 to 50 mass parts per 100 mass parts of the component (A).

A UV ray and an ionizing radiation such as an electron beam, an α ray, a β ray, a γ ray and the like are used as an active energy ray used for curing the unsaturated group-containing urethane oligomer which is a curable liquid resin used as the sealing material described above. A xenon lamp, a low pressure mercury lamp, a high pressure mercury lamp, a ultrahigh pressure mercury lamp and the like can be given as a UV ray source. Atmosphere in which a UV ray is irradiated is preferably inert gas atmosphere of nitrogen gas, carbon dioxide gas and the like or atmosphere in which an oxygen concentration is reduced, and curing can be carried out as well in a usual air atmosphere. The irradiation atmosphere temperature can usually be 10 to 200° C. Further, baking can be carried out after curing to remove volatile components. In this case, the baking temperature is preferably 100 to 150° C.

In applying the composition described above to an adherend, it can be applied by an optional method using a coating liquid in which temperature is adjusted, if necessary, and which is controlled to a fixed viscosity, and capable of being used are, for example, methods such as gravure coating, roll coating, spin coating, reverse coating, bar coating, screen coating, blade coating, air knife coating, dipping, dispensing and the like. The composition described above is coated, molded and then irradiated with an energy ray, whereby the coated layer is cured, and a member provided with a sealing layer can be obtained.

In a production process for the sealing material of the present invention, a value of a viscosity of the above sealing material has to be maintained in a stable state at room temperature for 6 months in order to inhibit a thickening phenomenon with the passage of time during storage at room temperature and reduce scattering in dispenser work. In order to achieve it, the production process comprises preferably a step (step 1) of stirring and mixing the energy ray-curable liquid resin of the component (A), the compound of the component (B) containing at least one carbodiimide group in a molecule and the thickener of the component (C) by means of a mixer and a step (step 2) of aging (curing) the obtained mixed liquid in a constant temperature bath.

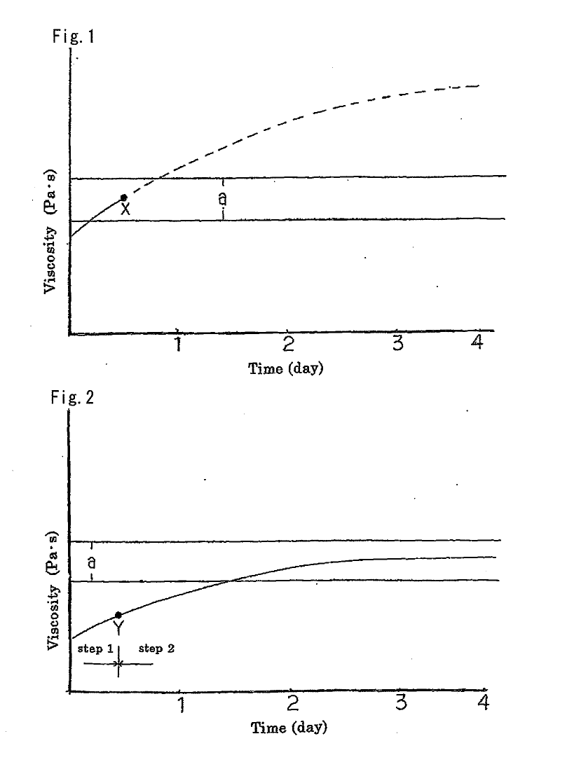

The production process for the sealing material of the present invention shall be explained with reference to FIG. 1 and FIG. 2. A viscosity (Pa·s) of the sealing material is shown in an axis of ordinate; time (day) is shown in an axis of abscissa; and a represents a width of the preferred viscosity.

FIG. 1 is a schematic drawing showing a change in a viscosity of a sealing material with the passage of time which shows a conventional example.

The energy ray-curable liquid resin of the component (A), the compound of the component (B) containing at least one carbodiimide group in a molecule and the thickener of the component (C) are stirred and mixed on a fixed temperature condition by means of a mixer, and stirring and mixing is stopped at the point of time in which a curve (1) reaches the preferred viscosity (X). The mixture is used as the sealing agent.

However, when a dispenser is used, the viscosity is elevated during use as shown by a dotted line since the dispenser is used while keeping warm, and the viscosity deviates from the preferred range, resulting in scattering. When time for reaching the point (X) has to be shortened further more, the thickener can be increased, but scattering caused by the work of the dispenser is further increased.

FIG. 2 is a schematic drawing showing a change in a viscosity of a sealing material with the passage of time which shows the embodiment of the present invention.

In the present invention, stirring and mixing of the component (A), the component (B) and the component (C) on a fixed temperature condition by means of a mixer is stopped at a point (Y) in a curve (2), and subsequently the mixed liquid is transferred from the mixer into a constant temperature bath which is controlled to a constant temperature and aged, whereby the viscosity is further elevated. The mixed liquid is further aged, though suitably determined by combination of the materials, usually for 1 to 7 days, whereby the viscosity is stabilized as shown in FIG. 2. Use of a dispenser while keeping warm using the above stabilized sealing material scarcely brings about a change in the viscosity and makes it possible to carry out the stable work.

In the case of FIG. 2, time required for reaching the point (Y) shall not specifically be restricted, and the mixed liquid can be transferred to the aging step of the subsequent step 2 as long as the component (A), the component (B) and the component (C) are evenly mixed to allow a viscosity to go up (the thickener is swollen), except that the stirring and mixing temperature is regulated.

The preferred range of the viscosity is suitably determined by the kind of the matrix which is the component (A), the kinds and the amounts of the component (B) and the component (C) and the temperature conditions in the step 1 and the step 2.

If the conditions are suited, the viscosity can be stabilized in almost the same curve only by stirring and mixing, but exclusive use of the mixer for 1 to 7 days for this purpose leads to a rise in the cost to a large extent.

Further, in the production process of the present invention, an amount of the thickener used can be decreased in order to use the thickener most effectively and efficiently, and an amount of an outgas (volatile organic compound) originating in the thickener can be reduced. An amount of the volatile organic compound (VOC) is preferably reduced up to a negligible range from the viewpoints of avoiding precision electronic equipments from being damaged by the outgas and preventing the environments of offices and houses from being deteriorated.

From the above viewpoints, an amount of the gas generated when the sealing material after cured is heated at a temperature of 150° C. for 20 minutes is preferably 500 ppm (based on mass) or less in terms of an amount reduced to n-decane.

A temperature range of stirring and mixing by means of the mixer in the step 1 is, though may suitably be determined by the solubilities of the component (A), the component (B) and the component (C), preferably 30 to 120° C., more preferably 50 to 100° C. A temperature range of aging in the step 2 is preferably 40 to 100° C., more preferably 50 to 90° C. The component (C) is completely dissolved at 50 to 120° C. in the step 1 and slowly cooled down to the aging temperature range in the step 2, whereby a structure for developing the viscosity is formed. A structure in which the viscosity is developed subsequently is allowed to grow in the step 2. It is particularly important to set the temperature conditions in the step 1 and the step 2, and setting of the temperature in the range described above allows the thickener to be efficiently swollen and makes it possible to obtain a sealing material in which a viscosity is stabilized.

Aging is preferably carried out in the step 2 for such an aging time that a rate of a change in a viscosity (Pa·s) of the mixed liquid at an aging temperature after 8 hours is 5% or less.

Further, the mixed liquid after finishing the step 2 has preferably a viscosity of 1 to 100 Pa·s at a shear rate of 10 s⁻¹ at 50° C.

In the step 1, at least one of a photopolymerization initiator, a cross-linking agent and a monomer can be added, if necessary, as the component (D) described above in addition to the components (A), (B) and (C) each described above.

### Examples

Next, the present invention shall be explained in further details with reference to examples, but the present invention shall by no means be restricted by these examples. Various measurements in the respective examples and comparative examples were carried out in the following manners.

### (1) Viscosity (Pa·s) of Sealing Material

Measured for 20 seconds at 50° C. and a shear rate of 10 s⁻¹ using a parallel plate in a viscoelasticity measuring equipment.

### (2) Curing Method

A film having a thickness of 0.6 mm was produced from the sealing material and irradiated with an energy ray to obtain a cured matter. A metal halide lamp was used for the energy ray, and irradiation was carried out in an air atmosphere on the conditions of an illuminance of about 130 mW/cm² and an integrated luminous energy of about 8000 mJ/cm². The above cured matter was further subjected to baking treatment at 120° C. for 4 hours in an air atmosphere.

### (3) Humid and Hot Deterioration Test-1

The sample was left standing on the conditions of 70° C. and a humidity of 95% RH for 4 months, and the values of the breaking strength (Tb) after one month, 2 months, 3 months and 4 months were measured. The values were shown by an index, wherein the breaking strength in starting the test was set to 100. It is shown that the larger the index is, the smaller the extent of the deterioration is.

### (4) Humid and Hot Deterioration Test-2

The sample was left standing at a temperature of 70° C. for each 4 months while changing a humidity to 0% RH, 70% RH and 95% RH, and the values of the breaking strength (Tb) after one month, 2 months, 3 months and 4 months were measured. The values were shown by an index, wherein the breaking strength in starting the test was set to 100. It is shown that the larger the index is, the smaller the extent of the deterioration is.

### (5) Breaking Strength (Tb)

Measured according to JIS K6251 using a No. 6 dumbbell.

### (6) Surface Adhesive Property

A cylindrical probe made of SUS304 was pressed onto a surface of the sheet having a thickness of 0.6 mm on a fixed condition, and a force required for drawing up was measured. A measured surface of the sheet is a face turned to an air side when cured by irradiating with a UV ray.

### Measuring Conditions:

Measuring environment: 25° C.
Probe diameter: φ5.0 mm
Pushing speed: 120 mm/minute
Pushing load: 3 seconds at 30 gf
Drawing-up speed: 600 mm/minute

### (7) JIS-A Hardness

A hardness of the cured matter was measured according to JIS K6253 by means of a type A durometer. A matter having a thickness of 6 mm which was obtained by laminating 10 sheets having a thickness of 0.6 mm was used as the test body.

### (8) Measurement of Permanent Strain (C. S)

Measured according to JIS K6252.

### (9) Moisture Permeability

Measured on the conditions of 40° C. and a relative humidity of 90 % according to JIS 20208 using a moisture permeable cup of an A method described in JIS L1099. The sheet having a thickness of 0.8 mm was used as the test body.

### (10) Adhesive Property

The sealing material was coated on an adherend of a nickel-plated aluminum plate based on JIS K6256 and irradiated with an energy ray to obtain a cured matter, and an adhesive property (unit: gf) thereof was measured. A metal halide lamp was used for the energy ray to carry out irradiation in an air atmosphere on the conditions of an illuminance of 130 mW/cm² and an integrated luminous energy of 8000 mJ/cm².

### (11) Production of Urethane Oligomer A

A four neck flask of one liter equipped with a stirrer, a cooling tube and a thermometer was charged with 400 g of a polyesterdiol compound (number average molecular weight: 2000) obtained from 2,4-diethyl-1,5-pentanediol and phthalic anhydride, 82.4 g of norbornanediisocyanate and 0.10 g of di-t-butyl-hydroxyphenol which was an antioxidant to react them at 80° C. for 2 hours. Then, 46.2 g of 2-hydroxyethyl acrylate, 0.10 g of p-methoxyphenol which was a polymerization inhibitor and 0.06 g of titanium tetra(2-ethyl-1-hexanolate) as an addition polymerization catalyst were added thereto to carry out reaction at 85° C. for 6 hours. A part of the reaction liquid was taken out to confirm the end point of the reaction by disappearance of an absorption peak of an isocyanate group at 2280 cm⁻¹ in an infrared absorption spectrum, and a urethane oligomer used as the component (A) was obtained. A number average molecular weight of the urethane oligomer thus obtained was determined in terms of a polystyrene-reduced value by means of a gel permeation chromatography to find that it was 18000.

### (12) Production of Sealing Material

A mixture was produced in advance by blending 100 mass parts of the urethane oligomer obtained above with 25 mass parts of a monomer (phenoxyethyl acrylate) and 2 mass parts of a polymerization initiator (4-(2-hydroxyethoxy)phenyl 2-hydroxy-2-propyl ketone).

### Examples 1 to 9 and Comparative Example 1

A prescribed amount of the mixture produced in (12) described above was kneaded with the prescribed amounts of a carbodiimide compound described in Table 1 which is the component (B) and isobornyl acrylate or dicyclopentanyl acrylate which is the component (D) at 70° C. by means of a planetary mixer to obtain sealing materials of Examples 1 to 9. The carbodiimide compound described above was not added in Comparative Example 1 to prepare a sealing material.

The above sealing materials were cured by the method of (1) described above, and the cured matters obtained in Examples 1 to 3 and Comparative Example 1 were used to carry out evaluations thereof by the humid and hot deterioration test-1 described above. Further, the values of the breaking strengths (Tb) after 4 months were measured in Examples 4 to 9. The evaluation results thereof are shown in Table 1.

Also, a matter obtained by curing the sealing material of Example 2 by the method of (1) described above was used to carry out evaluation thereof by the humid and hot deterioration test-2 described above. The evaluation results thereof are shown in Table 2.

Further, matters obtained by curing the sealing materials of Examples 1 to 9 and Comparative Example 1 by the method of (1) described above was used to evaluate a surface adhesive property, a hardness, a permanent compression strain, a moisture permeability and an adhesive property. The evaluation results thereof are shown in Table 3.

TABLE 1

| | | | CE | Example | | | | | | | | |
|---|---|---|---|---|---|---|---|---|---|---|---|---|
| Respective components (mass parts) | | | 1 | 1 | 2 | 3 | 4 | 5 | 6 | 7 | 8 | 9 |
| Component (A) | Urethane oligomer | | 100 | 100 | 100 | 100 | 100 | 100 | 100 | 100 | 100 | 100 |
| Component (B) | Carbodiimide compound*¹ | | 0 | 1 | 2 | 3 | 1 | 1 | 1 | 1 | 2 | 2 |
| Component (D) | Isobornyl acrylate*² | | — | — | — | — | 5 | 10 | — | — | 5 | — |
| | Dicyclopentanyl acrylate*³ | | — | — | — | — | — | — | 5 | 10 | — | 5 |
| | Phenoxyethyl acrylate*⁴ | | 25 | 25 | 25 | 25 | 25 | 25 | 25 | 25 | 25 | 25 |
| Evaluation: | Days for | After 1 month | 70 | 109 | 93 | 109 | — | — | — | — | — | — |
| Breaking strength (Tb | leaving | After 2 months | 38 | 96 | 119 | 112 | — | — | — | — | — | — |
| index) (condition for | standing | After 3 months | 34 | 79 | 115 | 120 | — | — | — | — | — | — |
| leaving standing: | | After 4 months | 18 | 50 | 75 | 113 | 50 | 51 | 50 | 50 | 75 | 76 |
| 70° C., 95% RH) | | | | | | | | | | | | |

CE: Comparative Example
Remarks:
*¹Liquid carbodiimide compound; trade name “Elastostab H01”, manufactured by Nisshinbo Industries, Inc.
*²Isobornyl acrylate; “IBXA”, manufactured by Osaka Organic Chemical Industry Ltd.
*³Dicyclopentanyl acrylate; “F513A”, manufactured by Hitachi Chemical Co., Ltd.
*⁴Phenoxyethyl acrylate; “Light Acrylate PO-A”, manufactured by Kyoeisha Chemical Co., Ltd.

TABLE 2

| | | After 1 | After 2 | After 3 | After 4 |
|---|---|---|---|---|---|
| | | month | months | months | months |
| Conditions | 70° C., 0% RH | 123 | 121 | 104 | 96 |
| for leaving | 70° C., 70% RH | 107 | 111 | 113 | 91 |
| standing | 70° C., 95% RH | 93 | 119 | 115 | 75 |
| Sample | | | | | |
| (Example 2) | | | | | |

TABLE 3

| | | | CE | Example | | | | | | | | |
|---|---|---|---|---|---|---|---|---|---|---|---|---|
| | | | 1 | 1 | 2 | 3 | 4 | 5 | 6 | 7 | 8 | 9 |
| Dumbbell | 100% | MPa/mm² | 0.94 | — | 0.89 | — | — | — | — | — | — | — |
| | modulus | | | | | | | | | | | |
| | Breaking | MPa/mm² | 5.68 | — | 8.25 | — | — | — | — | — | — | — |
| | strength | | | | | | | | | | | |
| | (Tb) | | | | | | | | | | | |
| | Breaking | % | 205 | — | 228 | — | — | — | — | — | — | — |
| | elongation | | | | | | | | | | | |
| | (Eb) | | | | | | | | | | | |
| Surface adhesive property | | gf/φ5 mm | 257 | 155 | 155 | 113 | 29 | 32 | 50 | 35 | 109 | 129 |
| JIS-A hardness | | degree | 35.7 | 36.1 | 35.3 | 34.4 | 36.5 | 36.7 | 36.6 | 36.8 | 35.8 | 35.7 |
| Permanent | 70° C. 22 | % | 10 | — | 6 | — | — | — | — | — | — | — |
| compression | hours + room | | | | | | | | | | | |
| strain | temperature | | | | | | | | | | | |
| | 24 hours | | | | | | | | | | | |
| Moisture | 40° C. 95% | g/24 hr · m² | 19.8 | 19.2 | 20.8 | 19.3 | 17.4 | 16.3 | 17.6 | 16.5 | 17.6 | 17.5 |
| permeability | RH | | | | | | | | | | | |

| | | | | | | | | | | | |
|---|---|---|---|---|---|---|---|---|---|---|---|
| Adhesive property | gf | 1213 | 1187 | 1053 | 972 | 1551 | 1861 | 1618 | 1904 | 1465 | 1485 |

CE: Comparative Example

It can be found from the results shown in Table 1 that the ester base urethane resins containing carbodiimide are less reduced in a breaking strength (Tb) on the conditions for leaving standing over a long period of time even in the accelerating deterioration test on the severe conditions of 70% and 95% RH and that they are improved to a large extent as compared with Comparative Example 1.

It can be found from the results shown in Table 2 that the humid and hot conditions were changed in Example 2 in which 2 mass parts of the carbodiimide compound was added and that as a result thereof, the breaking strengths (Tb) was less changed by a change in the conditions and provided with an excellent holding property.

Further, it can be found from the results shown in Table 3 that the moisture permeability was improved in Examples 4 to 9 in which the monomer component (D) was further added and that the surface adhesive property was notably improved (reduced). Also, it can be found that the adhesive property to the adherend was enhanced as well to a large extent. This makes it easy to detach, for example, an HDD cover and enhances the durability against an external force in reuse.

### Example 10

The urethane oligomer 100 mass parts of the component (A) obtained in (11) described above was blended with 1 mass part of the carbodiimide compound of the component (B) (trade name “Elastostab H01”, manufactured by Nisshinbo Industries, Inc.), 25 mass parts of a monomer (phenoxyethyl acrylate) of the component (D) and 2 mass parts of a polymerization initiator (4-(2-hydroxyethoxy)phenyl 2-hydroxy-2-propyl ketone) to produce in advance a mixture.

Added to the mixture described above was 2 mass parts of ADVITROL 100 (trademark, manufactured by Sud-Chemie Catalysts Inc., hydrogenated castor oil) as the thickener of the component (C) per 100 mass parts of the urethane oligomer contained in the mixture, and they were stirred at a temperature set to 80° C. for one hour by means of a planetary mixer. Then, the mixture was stirred while slowly cooling, and the step 1 was terminated after confirming that the thickener was dispersed and that a temperature of the material became 40° C. Then, aging in the step 2 was carried out, and the step 2 was finished after confirming that a change rate in a viscosity (Pa·s) of the mixture after 8 hours was 5% or less. The viscosity after finishing the step 2 was 76 Pa·s at 50° C.

The sealing material thus obtained was extruded in the form of a gasket onto a plate face with one stroke by means of a dispenser while warming. The viscosity was stable, and the gasket having a narrow line width and a large height could readily be formed on a cover body to thereby obtain an extruded form having a high precision.

An amount of gas produced when the sealing material after cured was heated at 120° C. for 10 minutes was 500 ppm (based on mass) in terms of an n-decane-reduced amount.

### INDUSTRIAL APPLICABILITY

According to the present invention, capable of being provided are a sealing material which is excellent in a durability on a humid and hot condition and maintains a low moisture permeability and which is excellent in an adhesive property to an adherend and provides an extruded form having a high precision, a production process for a sealing material which is excellent in a long term storage stability and gaskets having the characteristics described above prepared by using the above materials. Further, the cured matter of the sealing material is reduced in a surface adhesive property and therefore improved in a durability against an external force in reuse.

1. A sealing material comprising an unsaturated group-containing ester base urethane oligomer (A) which is an energy ray-curable liquid resin and 0.01 to 10 mass parts of a compound (B) containing at least one carbodiimide group in a molecule per 100 mass parts of the above component (A).

2. The sealing material as described in claim 1, wherein the energy ray-curable liquid resin (A) is represented by the following Formula (I):
R¹—O—CONH—R²—NHCO—(—O—R³—O—CONH—R²—NHCO)ₚ-(-A-CONH—R²—NHCO—)_{q}—(—O—R³—O—CONH—R²—NHCO—)ᵣ—O—R¹ (I)
[in Formula (I), R¹ is a hydroxyl group-eliminated residue of a monool compound containing at least either unsaturated group of a (meth)acryloyl group and a vinyl group; R² is an isocyanate-eliminated residue of an organic diisocyanate compound; R³ is a hydroxyl group-eliminated residue of a polyesterdiol compound having a number average molecular weight of 1×10³ to 1×10⁴ and containing a cyclic group or a branched chain group; A is a hydrogen group-eliminated residue of a diamine compound or a hydrogen group-eliminated residue of a diol compound; p and r each are 0 to 7, and q is 0 to 3, provided that when q is 0, 1≦p+r≦10] and an unsaturated group-containing urethane oligomer having a number average molecular weight of 5×10³ to 5×10⁴.

3. The sealing material as described in claim 2, wherein R³ in Formula (I) is a hydroxyl group-eliminated residue of the polyesterdiol compound described above which is obtained by condensing cyclic group-containing dicarboxylic acid with diol or a hydroxyl group-eliminated residue of the polyesterdiol compound modified by reacting cyclic group-containing dicarboxylic anhydride with diol.

4. The sealing material as described in claim 2, wherein R¹ in Formula (I) is a hydroxyl group-eliminated residue of the monool compound described above which is either of hydroxyalkyl (meth)acrylate and hydroxyalkyl vinyl ether.

5. The sealing material as described in claim 1, wherein the unsaturated group-containing urethane oligomer (a case of q=0 in Formula (I)) of the component (A) is obtained by subjecting the polyesterdiol compound described above and the organic diisocyanate compound described above to polyaddition reaction to form an adduct having isocyanate groups at both ends and then adding the monool compound described above to the above isocyanate groups.

6. The sealing material as described in claim 1, wherein the unsaturated group-containing urethane oligomer (a case of q≠0 in Formula (I)) of the component (A) is obtained by subjecting the polyesterdiol compound described above and the organic diisocyanate compound described above to polyaddition reaction to form an adduct having isocyanate groups at both ends, then adding each end of the diamine compound described above or the diol compound described above to the isocyanate group at one end of the above adduct and adding the monool compound described above to the isocyanate group at the other end of the above adduct.

7. The sealing material as described in claim 1, wherein the compound (B) containing a carbodiimide group is a liquid polycarbodiimide compound having a viscosity of 0.1 to 100 Pa·s.

8. The sealing material as described in claim 7, wherein the component (B) described above is a liquid polycarbodiimide compound having a viscosity of 0.5 to 10 Pa·s.

9. The sealing material as described in claim 1, further comprising a thickener (C) imparting a thixotropic property.

10. The sealing material as described in claim 9, comprising 0.5 to 10 mass parts of the thickener (C) per 100 mass parts of the component (A).

11. The sealing material as described in claim 9, wherein the thickener (C) is an organic thickener.

12. The sealing material as described in claim 11, wherein the organic thickener is hydrogenated castor oil.

13. The sealing material as described in claim 1, further comprising at least one of a photopolymerization initiator, a cross-linking agent and a monomer as a component (D).

14. The sealing material as described in claim 13, comprising 1 to 70 mass parts of a (meth)acrylic acid ester monomer as the component (D) per 100 mass parts of the component (A).

15. The sealing material as described in claim 14, wherein the (meth)acrylic acid ester monomer described above has a glass transition temperature of 50° C. or higher.

16. The sealing material as described in claim 15, wherein the (meth)acrylic acid ester monomer described above is dicyclopentanyl (meth)acrylate and/or isobornyl(meth)acrylate.

17. A production process for the sealing material comprising the energy ray-curable liquid resin (A), the compound (B) containing at least one carbodiimide group in a molecule and the thickener (C) each described in claim 1, comprising a step (step 1) of stirring and mixing the component (A), the component (B) and the component (C) by means of a mixer and a step (step 2) of aging (curing) the obtained mixed liquid in a constant temperature bath.

18. The production process for the sealing material as described in claim 17, wherein a temperature in stirring and mixing by the mixer in the step 1 described above falls in a range of 30 to 120° C.

19. The production process for the sealing material as described in claim 17, wherein in the step 2, a temperature in the aging falls in a range of 40 to 100° C., and the aging is continued until a rate of a change in a viscosity (Pa·s) of the mixed liquid at the aging temperature after 8 hours reaches 5% or less.

20. The production process for the sealing material as described in claim 17, wherein the mixed liquid after finishing the step 2 has a viscosity of 1 to 100 Pa·s at a shear rate of 10 s⁻¹ at 50° C.

21. A sealing material obtained by using the production process as described in claim 17.

22. A gasket obtained by curing the sealing material as described in claim 1.

23. A gasket obtained by curing the sealing material as described in claim 22.
